(19) United States
(12) Patent Application Publication
(10) Pub. No.: US 2008/0257948 A1
(43) Pub. Date: Oct. 23, 2008

(54) System and method for dispensing beverages

(76) Inventors: Randel J. Jochim, Newport Beach, CA (US); Ann M. Jochim, Newport Beach, CA (US); Brent T. Jochim, Newport Beach, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/737,581

(22) Filed: Apr. 19, 2007

(51) Int. Cl. G06F 17/00

(52) U.S. Cl. 235/375; 705/75

(57) ABSTRACT

A system and method of dispensing a beverage to a customer is described, wherein the system includes a first scanner and a second scanner for identifying a unique identifier, each operatively connected to a computer system. Upon purchasing a beverage under an applicable contractual scheme, management of a beverage outlet issues a unique identifier to the customer and registers the unique identifier in the computer system. When the customer wishes to take a fill or a refill of the beverage, she must pass the unique identifier across a second scanner that will record the incremental use of the identifier. The computer system assesses whether or not a rule of use has been violated, and will only permit the dispenser to dispense where the rule has not been violated.

### BACKGROUND OF THE INVENTION

The present invention relates to systems for delivery of fluids from a central reservoir. More specifically the invention relates to systems for controlling the delivery of beverages from a beverage dispenser, to customers who have purchased the right to help themselves to servings thereof.

Beverage dispensers in fast food and other food and entertainment outlets are well known. They play an important role in the economy of such facilities, a role that has changed over the passage of time.

Initially, beverage dispensers were typically positioned behind the counter of a serving establishment, where management would control the pouring and serving of the beverage. A departure from this arrangement took place when beverage dispensers, more especially soda dispensers, in many establishments were moved out from behind the counter to a position where the customers could serve themselves. This move was undertaken in the realization that the speed of service could be improved if the routine step of pouring and serving a beverage was removed from the serving staff and transferred to the customer. Management retained some control over the dispensing of the beverages once paid for, in that the customer was given a proprietary cup in the understanding that he or she would take a single serving. Customers who had not paid for a beverage would not be in possession of a proprietary cup, and could not help themselves using their own cup without being noticed. (The term “proprietary cup” as used herein is intended to refer to a cup that may be identified by management of a serving establishment as one originating from the establishment, and which gives the possessor the right to a helping of beverage therein. This is typically achieved by applying some marking on the cup such as a trade mark, or a trade dress configuration of the cup.)

Thus there emerged the familiar beverage dispenser with its bank of nozzles at most fast food outlets across the nation.

However, the economy of beverage sales in this context underwent further development. Having established a system where the customers could help themselves to a single helping of a purchased beverage, management realized that it was difficult to enforce the understanding that only one serving would be taken. Any attempt to call a customer on taking an additional helping was considered rude, and bad for business. Accordingly, by setting the price at an appropriate level, management invited customers to a “bottomless cup” of the beverage purchased, safe in the knowledge that a single customer could drink only a limited amount before having to voluntarily suspend consumption—at least, where the beverage was a soda, fruit juice, or other non-alcoholic beverage.

Yet, even this relaxation to the contractual basis for self service has not been sufficient to prevent abuse by customers. Once it became accepted commercial practice to permit customers to help themselves more than once to a beverage paid for, some customers have begun to insist that it is their right to leave the premises with their proprietary cup and to return later in the day to refill it. Even more extreme, some customers have begun to insist that it is their right to return the next day, or whenever, to fill up their proprietary cup. Again, some customers are known to pass their proprietary cup to others for use in the store at which it was purchased or even in another branch of a store that is franchised, so that one purchased cup may result in a number of helpings far beyond that contemplated by the initial contractual scheme. This practice is becoming an annoying management and economic problem for proprietors of food outlets that use self serve beverage dispensers.

Although management can easily make it clear from the outset that a cup paid for entitles a customer to refill the cup only while on the premises the first time, or the first day, or under whatever contractual scheme may be applicable, such terms are difficult to impose on customers who insist that they have not left the premises, or are otherwise in compliance with the scheme, when in fact they are not. Moreover, it is bad for business to engage in a public dispute with a customer on the premises about what they allegedly have and have not paid for.

Thus, there is a need in the art for an improved system and method for dispensing beverages where customers are allowed to help themselves. The present invention addresses these and other needs.

### SUMMARY OF THE INVENTION

According to a preferred embodiment of the invention, there is described a system for dispensing a beverage suitable for use in food outlet establishments, beer gardens, and other refreshment type situations.

In a preferred embodiment, the system for dispensing a beverage comprises a beverage dispenser and a computer system operatively connected to the beverage dispenser. A first scanner is provided, and is operatively connected to the computer system, the first scanner being configured to read a unique identifier such as a bar code or a radio frequency tag. The first scanner is accessible to the manager of a food outlet using the same. A second scanner is further provided, and is also operatively connected to the computer system, the second scanner being also configured to read the unique identifier. The second scanner is accessible by a customer who has purchased the right to servings of a beverage.

The computer system is configured by programming steps so that, when the unique identifier is passed for a first time across the first scanner, the computer system performs at least one action selected from: (i) registering the unique identifier identity; and (ii) registering the then current time.

The computer system is further configured by programming steps so that, when the unique identifier is passed across the second scanner, the computer system performs at least one action selected from: (i) ascertaining the then current time; and (ii) ascertaining the number of times the unique identifier has been passed across the second scanner.

In a preferred aspect of the invention, the computer system is further configured by programming steps so that, when the unique identifier is passed across the second scanner, the computer system computes whether or not a rule of use, pre-programmed into the computer system, has been violated. In an additional aspect of the invention, the computer system may be further configured to visually display whether or not the rule of use has been violated. If the rule of use has been violated, the computer system may be further configured to disable the beverage dispenser from dispensing beverage. If the rule of use has not been violated the computer system is further configured to enable the beverage dispenser to dispense beverage.

In yet another aspect, the computer system is configured to visually display an identifier use history upon the identifier being passed across the first scanner.

In another embodiment, the invention includes a method of selling a beverage which may include initially, providing a purchaser of the beverage with a unique identifier. Before giving the identifier to the customer, it is registered in a computer system, where its specific identity is recorded. Registering the specific identity may include passing the identifier across a first bar code scanner, or radio frequency tag scanner. Then, each time the purchaser wishes to help herself to a beverage from the beverage dispenser, the purchaser is required to permit the computer system to read the unique identifier before the purchaser attempts to obtain a serving of the beverage. This step may be accomplished through a second scanner, different from the first scanner, but accessible to the purchaser. The computer system then determines whether or not a rule of use has been violated. Making the determination whether or not a rule of use has been violated may include ascertaining how many times an identifier has been read by the computer system, and/or it may include ascertaining the time of day. For example, a rule of use might be that the purchaser is entitled to only a set number of refills based on that particular identifier. Or, the rule of use might be that the purchaser can have as many helpings as she likes on the day of purchase, but on no other day. If the rule of use has been violated, the computer system does not enable the beverage dispenser to any dispense beverage. If the rule of use has not been violated, the computer system enables the beverage dispenser to dispense beverage to the purchaser.

In another aspect of this embodiment, the computer system disables the beverage dispenser from dispensing beverage each time one serving of beverage has been dispensed. This forces each purchaser to pass her identifier over the second scanner before she might expect to obtain a serving of beverage. In yet another aspect, the computer system may visually display whether or not the rule of use has been violated, so that a purchaser is left in no doubt that the dispenser is functional and not broken, but that the computer system has determined that no beverage may be dispensed. In a further aspect, the computer system may visually display the use history of the unique identifier, particularly when the unique identifier is passed across the first scanner by the manager of the food outlet. This enables the manager of the establishment to check on the use history of an identifier, without leaving his position, and to answer queries by a customer. In further aspects, the unique identifier of this embodiment may be a bar code or a radio frequency tag. Either type of identifier may be attached to a cup, or be kept separate from a cup and provided on a credit card, or similar, such as a wrist band.

These and other advantages of the invention will become more apparent from the following detailed description thereof and the accompanying exemplary drawings.

### BRIEF DESCRIPTION OF THE DRAWINGS

FIG. 1 is a schematic depiction of a configuration of components of the present invention

FIG. 2 is a flow diagram depicting a sequence of steps taken according to one embodiment of the present invention.

FIG. 3 is a flow diagram depicting a sequence of steps taken according to another embodiment of the present invention.

### DETAILED DESCRIPTION OF THE PREFERRED EMBODIMENTS

With reference to the figures, which are provided for exemplification only, and not limitation, a method and system for dispensing beverages is described that addresses shortcomings found in the art.

A common feature of all embodiments of the invention is that it provides that whenever management of an refreshment outlet establishment sells to a customer the right to help herself to a beverage under the contractual scheme then applicable, the customer is given a unique identifier 22, most preferably in the form of a bar code, although in other embodiments a radio frequency tag may be used. In a preferred embodiment of the invention, a unique bar code will have been printed on a cup 20 that is given to the customer. In an alternative embodiment, a unique bar code previously printed on a roll of sticky labels may be removed from the roll and applied to such cup before it is given to the customer. In yet a further embodiment, the unique identifier need not be applied to the cup, but may be given directly to the customer, for example the unique identifier may be given on a “credit” card, affixed to a wrist band, or the like.

Required for use in the present invention, in conjunction with the uniquely identified cup, is an identifier reading system. Where the cup is given a bar code, the identifier reading system is a bar code scanner system. Bar code scanning technology is well known in the art, and is described in numerous references, for example U.S. Pat. No. 6,905,070, U.S. Pat. No. 5,440,110, and the patents recited therein. These references and their recited prior art references are incorporated herein by reference. Radio frequency tag technology is also well known in the art, and is described in numerous references, for example U.S. Pat. No. 7,071,824, U.S. Pat. No. 6,894,614, and the patents recited therein. These references and their recited prior art references are incorporated herein by reference.

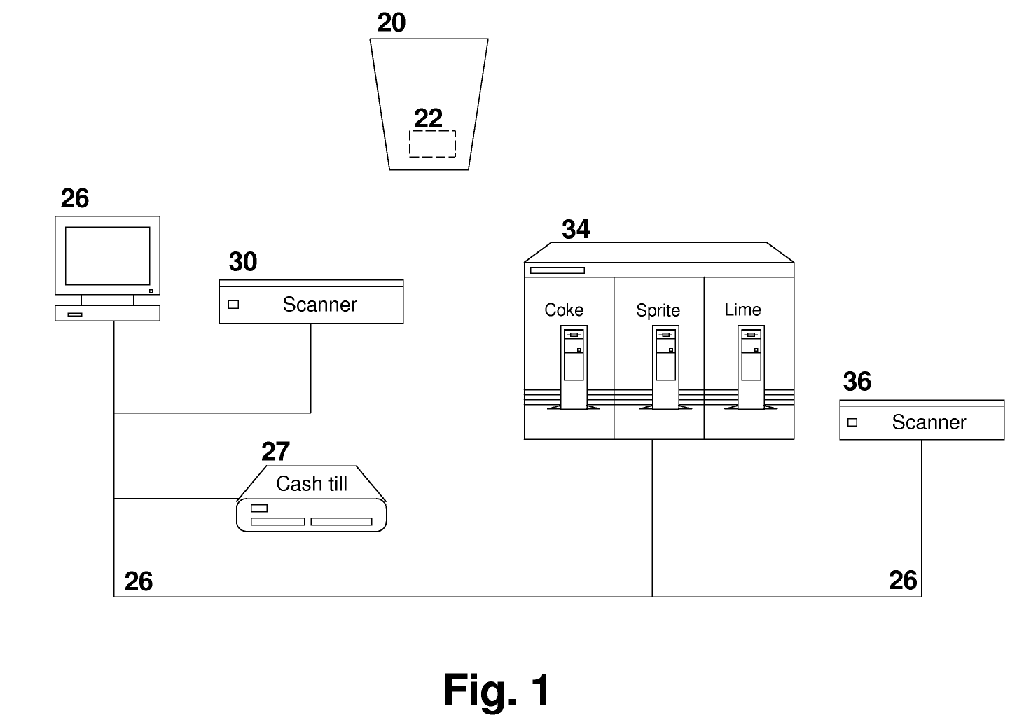

The identifier reading system of the present invention is configured to be accessed by both a manager serving behind the counter, and by a customer, as described further below. In a preferred embodiment, the identifier reading system may be a component of a computer system 26 under which the store, or serving establishment, operates to maintain control of outgoing sales, and stock in trade. As exemplified in FIG. 1, preferably, the identifier reading system includes a first scanner 30 operably connected to the computer system 26 and preferably accessible only by the manager, and a second scanner 36 operably connected to the computer system 26 and accessible by a customer. A beverage dispenser 34 is operably connected to the computer system 26, and hence it is operably connected to the two scanners 30, 36, as exemplified in FIG. 1. The term “operably connected” as used herein shall include connection via cable, radio, or other form of connection as used to operationally connect hardware systems for communication between their various elements.

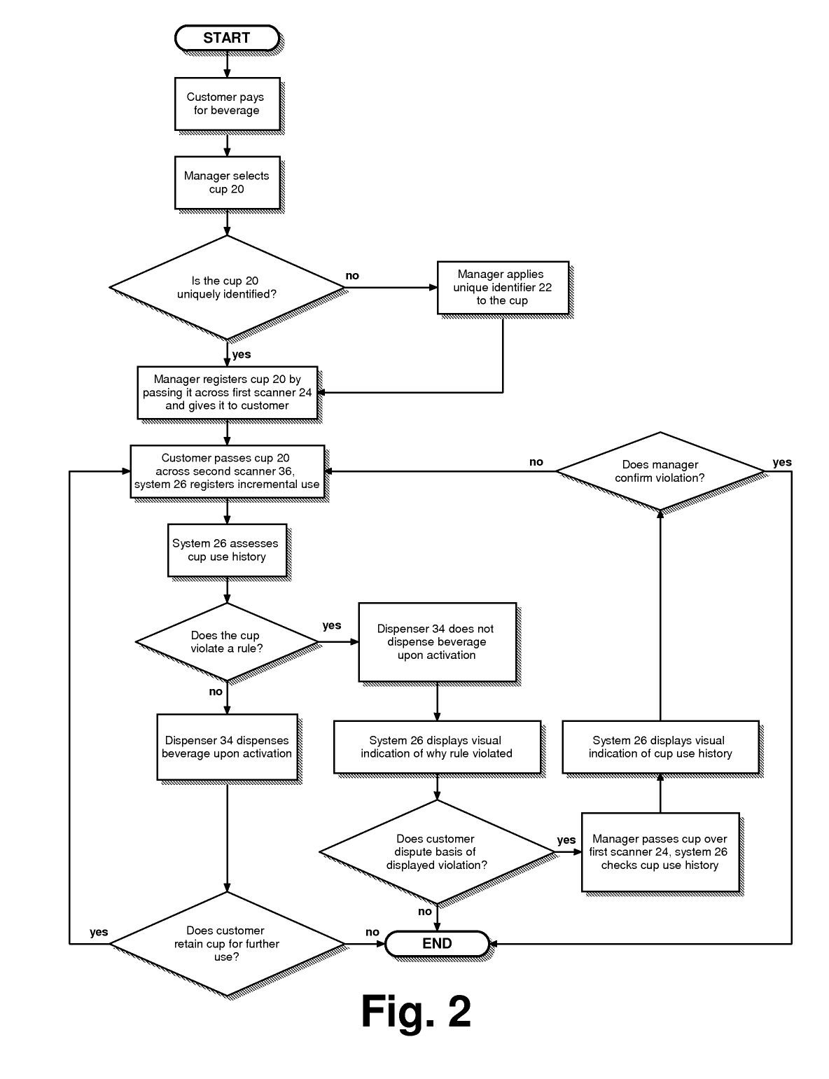

In operation of a first embodiment of the invention, the logical flow of which is exemplified in FIG. 2, the manager, upon payment for a beverage, may select a cup 20 for giving to the customer to use. If the cup 20 does not have a pre-printed bar code, the manager may apply a bar code to the cup by way of a sticky label 28 having a bar code printed thereon, and then hand the cup 20 to the customer.

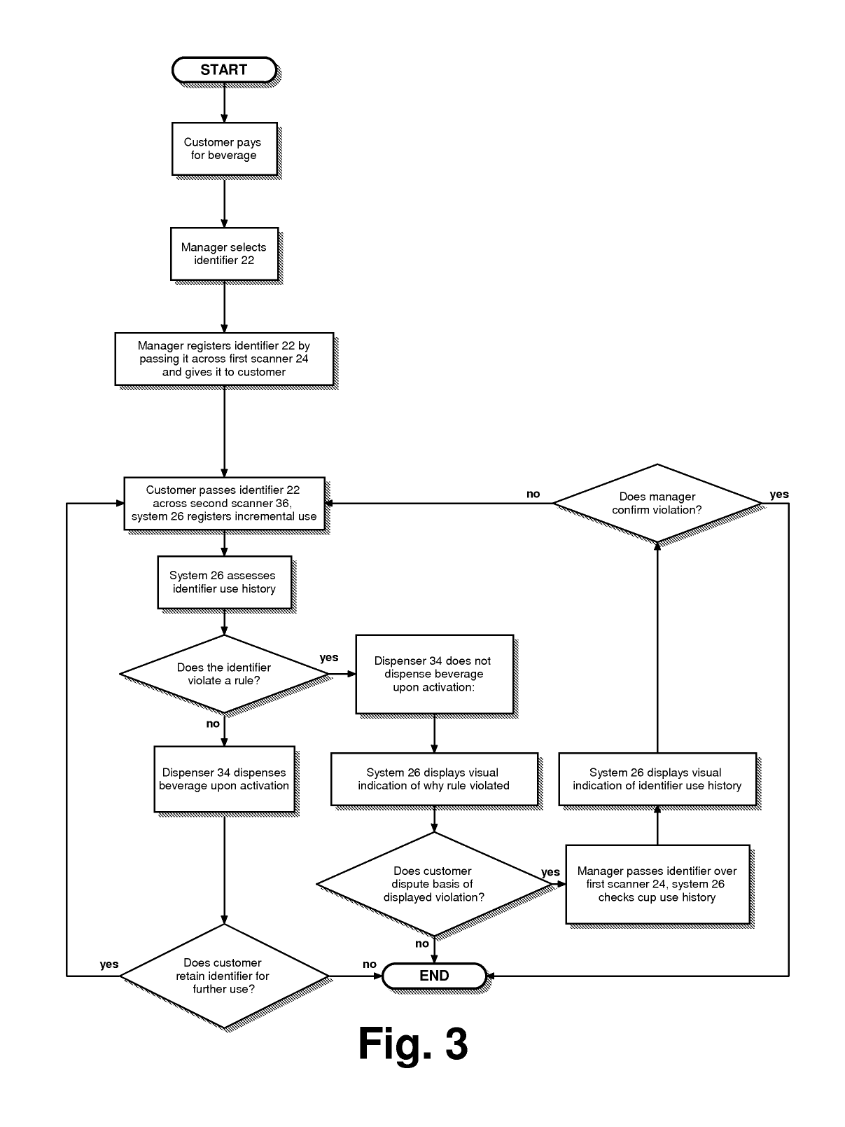

In an alternative embodiment of the invention, the logical flow of which is exemplified in FIG. 3, the manager, upon payment for a beverage, may hand directly to the customer a separate unique identifier 22 in the form described above. In this case, the customer may use a cup provided by the management, or may use her own cup.

From this point of use onward, the two embodiments follow essentially the same logical path during which a use history of the cup or the identifier is monitored to assess whether or not the customer is entitled to another beverage serving, depending on a rule of use that has been contractually established by management. In the first embodiment (FIG. 2), the cup is the item for which a use history is monitored via its unique identifier. In the second embodiment (FIG. 3) it is the identifier itself, not necessarily connected to a cup, that is monitored for violation of a rule of use.

Thus, continuing from the point at which the customer has paid for a beverage, the manager passes the unique identifier (which in the first embodiment of FIG. 2 is affixed to the cup 20) across the first scanner 30. Preferably, this is the same scanner that is used in connection with sale of all other items in the store, connected to the computer system 26 which may also run the store's cash till register 27. The first scanner 30 identifies the unique identifier code 22 (whether attached to cup, or not) and retains it in memory for later assessment as to whether the customer has a contractual right to a filling or re-filling of a beverage from the store's beverage dispenser 34.

The computer system 26 registers the identity of the unique identifier 22, and also, preferably, the time and store location (if the store is franchised) where the purchase was made. This information will be used to regulate the further legitimate use of the unique identifier 22 (or cup, where the identifier is attached to a cup) by the customer according to a set of rules that may be programmed into the computer 26, and which may be varied by the management according to the then current business strategy for selling beverages. A list of rules, according to preferred embodiments of the present invention, are set forth below.

The practical enforcement of any particular rule that has been set as applicable may proceed as follows. Once the manager has registered the unique identifier in the computer system 26, the customer approaches the beverage dispenser 34. The dispenser 34 is configured, in conjunction with the computer system 26 so that, before it will dispense any beverage, the customer must pass the unique identifier 22 across the second scanner 36 (which is operatively connected to the dispenser 34 via the computer system). The second scanner 36 identifies the particular unique identifier 22, and transmits the information to the computer system 26 that then ascertains whether or not the unique identifier 22 violates the then current rule for legitimate use that has been programmed into the computer system 26. The beverage dispenser 34 is configured so that, if the particular unique identifier 22 violates the rule, the dispenser dispenses nothing should the customer attempt to dispense any beverage. If the identifier 22 has not violated the rule, a beverage will be dispensed upon the customer activating the dispenser 34 in the usual way. In one aspect of the invention, if the identifier has not violated the rule, the computer system 26 is configured to reset the beverage dispenser 34 to dispense beverages, thus overwriting any previous instruction to withhold beverage dispensing.

Using this invention, the store manager need not be concerned to police the beverage dispenser for customers abusing what would otherwise be the case, namely that the dispenser would dispense beverage upon mere activation in the ordinary way. Policing the legitimate use of the beverage dispenser is left to the system and method of the present invention, leaving the manager free to carry out more productive activities in relation to the store.

Preferred under the present invention are the following rules of legitimate use that may be applied by management to a unique identifier 22 under the described invention:

The identifier entitles the customer to a filling if the identifier has been presented for filling since purchase no more than a fixed number of times, that number preferably being three;

The identifier entitles the customer to a filling if the store has not closed since the identifier was purchased.

The identifier entitles the customer to a filling if no more than a fixed number of hours have elapsed since the identifier was purchased, that number preferably being 24 hours.

In another aspect of the invention, the computer system 26 is configured by programming to be capable of capturing, and storing for later retrieval, display, and inspection, information relating to each time a registered identifier 22 is passed across the second scanner 36 by a customer to obtain a beverage helping, and displaying that information to management upon request. Preferably, such information will be displayed on the computer system 26 when the unique identifier 22 is passed across the first identifier reading system 24, thus enabling the manager to answer queries about the use history of the identifier 22 without leaving her position behind the counter.

In a preferred aspect, the information captured includes the time of day the cup is presented for filling on each occasion it is presented. Thus, if a customer complains that the dispensing machine 34 will not dispense a beverage, management may confirm when the cup was purchased, and at what times subsequent thereto the cup was presented for filling by the dispenser 34. Although the possibility for a dispute is always present, this kind of information will provide management with an improved basis upon which to assert and adhere to its position that the applicable rule for dispensing is being violated, if such is the case, and refuse to dispense further beverage.

Thus, the present invention provides a convenient, inexpensive, and efficient method for management to monitor the use of a beverage dispenser by customers who have purchased the right to help themselves to a serving of a beverage. It will be appreciated that this invention may find application in many different settings. It may be used by single fast food outlets. It may have application to fast food outlets that are franchised, in which the right to obtain a refill in another outlet may be permitted or denied under a rule of use programmed into the computer system 26, if such system is networked between the various branches of the outlet. It may be used at a beer garden, where customers may purchase a right to a set number of refills, or as many refills as they can drink before a certain hour. The variations to the rules of use that may be applied are not limited, and the preferred configuration of the system and method may accommodate these without modification thereto.

In one variation, the present invention may include a further feature, in which the beverage dispenser is configured to measure the actual quantity of liquid dispensed on the account of one unique identifier. This feature goes beyond simply being configured to determine the number of times the identifier has been passed across the second scanner, but records the actual quantity of beverage dispensed, as a result of the identifier being used to obtain a serving of beverage. This aspect has particular usefulness when the beverage being served is alcoholic, but the invention is not limited to this purpose. In this way, by programming the computer system 26 to include a rule of violation that sets an absolute limit to the amount of beverage that may be served, management may limit the absolute amount of beverage being served on account of any particular identifier.

It will be realized that the foregoing preferred specific embodiments have been shown and described for the purpose of illustrating the functional and structural principles of this invention and are subject to change without departure from such principles. Therefore, this invention includes all modifications encompassed within the spirit and scope of the following claims.

We claim:

1. A system for dispensing a beverage comprising:
a computer system;
a beverage dispenser operatively connected to the computer system;
a first scanner operatively connected to the computer system, the first scanner being configured to read a unique identifier; and
a second scanner operatively connected to the computer system, the second scanner being configured to read the unique identifier;
wherein, the computer system is configured so that:
(a) when the unique identifier is passed for a first time across the first scanner, the computer system performs at least one action selected from:
(i) registering the unique identifier identity; and
(ii) registering the then current time;
(b) when the unique identifier is passed across the second scanner, the computer system performs at least one action selected from:
(i) ascertaining the then current time; and
(ii) ascertaining the number of times the unique identifier has been passed across the second scanner.

2. The system of claim 1, wherein the computer system is configured so that, when the unique identifier is passed across the second scanner, the computer system computes whether or not a rule of use, pre-programmed into the computer system, has been violated.

3. The system of claim 2, wherein the computer system is further configured to visually display whether or not the rule of use has been violated.

4. The system of claim 2, wherein the computer system is further configured to disable the beverage dispenser from dispensing beverage if the rule of use has been violated.

5. The system of claim 2, wherein the computer system is further configured to enable the beverage dispenser to dispense beverage if the rule of use has not been violated.

6. The system of claim 5, wherein the computer system is configured so that, after the beverage dispenser dispenses a serving of beverage, the computer system disables the beverage dispenser from dispensing a further serving until a further unique identifier is passed across the second scanner.

7. The system of claim 1, wherein the computer system is further configured to visually display an identifier use history upon the identifier being passed across the first scanner.

8. The system of claim 1, wherein the unique identifier is a bar code.

9. The system of claim 1, wherein the unique identifier is a radio frequency tag.

10. The system of claim 1, wherein the computer system includes a cash register till.

11. The system of claim 1, wherein the beverage dispenser is configured to measure the amount of beverage that is dispensed upon activation by a user, and further wherein the computer system is configured so that when the unique identifier is passed across the second scanner, the computer system ascertains how much beverage has been dispensed in respect of the unique identifier.

12. A method of selling a beverage, comprising:
providing a purchaser of the beverage with a unique identifier;
registering the unique identifier in a computer system;
requiring the purchaser to permit the computer system to read the unique identifier each time before the purchaser attempts to obtain a serving of the beverage from a beverage dispenser;
determining, through the computer system, whether or not a rule of use has been violated;
disabling the beverage dispenser from dispensing beverage if the rule of use has been violated;
enabling the beverage dispenser to dispense beverage if the rule of use has not been violated.

13. The method of claim 12, further comprising disabling the beverage dispenser from dispensing beverage each time one serving of beverage has been dispensed.

14. The method of claim 12, wherein determining whether or not a rule of use has been violated includes visually displaying whether or not the rule of use has been violated.

15. The method of claim 12, further comprising visually displaying a use history of the unique identifier.

16. The method of claim 12, wherein providing a purchaser with a unique identifier includes providing a purchaser with a cup having a bar code.

17. The method of claim 12, wherein providing a purchaser with a unique identifier includes providing a purchaser with a credit card having a bar code.

18. The method of claim 12, wherein providing a purchaser with a unique identifier includes providing a purchaser with a cup having a radio frequency tag.

19. The method of claim 12, wherein providing a purchaser with a unique identifier includes providing a purchaser with a credit card having a radio frequency tag.

20. The method of claim 12, wherein registering the unique identifier in a computer system includes passing the unique identifier across a first scanner.

21. The method of claim 20, wherein passing the identifier across a first scanner includes passing the identifier across a first bar code scanner.

22. The method of claim 12, wherein requiring the purchaser to permit the computer system to read the unique identifier each time before the purchaser attempts to obtain a serving of the beverage from a beverage dispenser includes requiring the purchaser to pass the unique identifier across a second scanner.

23. The method of claim 22, wherein requiring the purchaser to pass the unique identifier across a second scanner includes requiring the purchaser to pass the unique identifier across a second bar code scanner.

24. The method of claim 12 wherein determining whether or not a rule of use has been violated includes ascertaining how many times the identifier has been read by the computer system.

25. The method of claim 12 wherein determining whether or not a rule of use has been violated includes ascertaining the time of day.

26. The method of claim 12 wherein determining whether or not a rule of use has been violated includes measuring how much beverage has been dispensed to a particular identifier.
